(19) United States
(12) Patent Application Publication
(10) Pub. No.: US 2016/0275527 A1
(43) Pub. Date: Sep. 22, 2016

(54) EVENT TICKET PRICING BASED ON A CONDITION

(71) Applicant: GameHedge LLC, Westfield, NJ (US)

(72) Inventor: Warren Friss, Westfield, NJ (US)

(73) Assignee: GameHedge LLC, Westfield, NJ (US)

(21) Appl. No.: 15/071,608

(22) Filed: Mar. 16, 2016

Related U.S. Application Data
(60) Provisional application No. 62/133,607, filed on Mar. 16, 2015.
(60) Provisional application No. 62/153,076, filed on Apr. 27, 2015.

(51) Int. Cl. G06Q 30/02; G06Q 10/02; G06Q 30/06

(52) U.S. Cl. CPC G06Q 30/02; G06Q 30/06; G06Q 10/02

(57) ABSTRACT

In one aspect, a method includes receiving electronically a ticket query for a spectator event; generating, in response to the ticket query, a ticket option comprising a refund based on at least one condition; sending electronically the ticket option; receiving electronically a ticket selection of the ticket option comprising the at least one condition; receiving data related to the at least one condition; determining if the at least one condition has occurred based on the data received and enabling a refund if the at least one condition is met.

### RELATED PATENT APPLICATIONS

This patent application claims priority to U.S. Provisional Patent Application No. 62/133,607, filed Mar. 16, 2015, and entitled “CONDITIONAL EVENT TICKETS” and U.S. Provisional Patent Application No. 62/153,076, filed Apr. 27, 2015, and entitled “CONDITIONAL FUTURE EVENT TICKETS,” each of which is incorporated herein by reference in its entirety.

### BACKGROUND

Millions of people buy tickets and attend spectator events each year. They often spend hundreds of dollars per ticket. However, there is no guarantee that these people will have a good experience. For example, in a team sporting event, the team they are rooting for may lose by a wide-margin. Ticket buyers often feel disappointed after a lopsided loss and feel that they did not get their money's worth.

### SUMMARY

In one aspect, a method includes receiving electronically a ticket query for a spectator event; generating, in response to the ticket query, a ticket option comprising a refund based on at least one condition; sending electronically the ticket option; receiving electronically a ticket selection of the ticket option comprising the at least one condition; receiving data related to the at least one condition; determining if the at least one condition has occurred based on the data received and enabling a refund if the at least one condition is met.

In another aspect, an apparatus includes electronic hardware circuitry configured to receive electronically a ticket query for a spectator event; generate, in response to the ticket query, a ticket option comprising a refund based on at least one condition; send electronically the ticket option; receive electronically a ticket selection of the ticket option comprising the at least one condition; receive data related to the at least one condition; determine if the at least one condition has occurred based on the data received and enable a refund if the at least one condition is met.

In a further aspect, an article includes a non-transitory computer-readable medium that stores computer-executable instructions. The instructions causing a machine to receive electronically a ticket query for a spectator event; generate, in response to the ticket query, a ticket option comprising a refund based on at least one condition; send electronically the ticket option; receive electronically a ticket selection of the ticket option comprising the at least one condition; receive data related to the at least one condition; determine if the at least one condition has occurred based on the data received and enable a refund if the at least one condition is met.

### BRIEF DESCRIPTION OF THE DRAWINGS

FIG. 1A is a block diagram of an example of a system to provide event ticket pricing based on a condition.

FIG. 1B is a block diagram of another example of a system to provide event ticket pricing based on a condition.

FIG. 2 is a flowchart of an example of a process to provide event ticket pricing based on a condition.

FIG. 3 is a block diagram of an example of a system to provide event ticket pricing based on a condition to ticket sellers.

FIG. 4 is a flowchart of an example of a process to provide event ticket pricing based on a condition to ticket sellers.

FIG. 5 is a block diagram of an example of a computer on which any portion of the process of FIGS. 2 and 4 may be implemented.

### DETAILED DESCRIPTION

Described herein are techniques to provide event ticket pricing based on one or more conditions. In one particular example, an event may be a spectator event such as, for example, a sporting event (such as, for example, baseball, football, hockey, basketball, volleyball, soccer and so forth), a play, a musical, a concert and so forth.

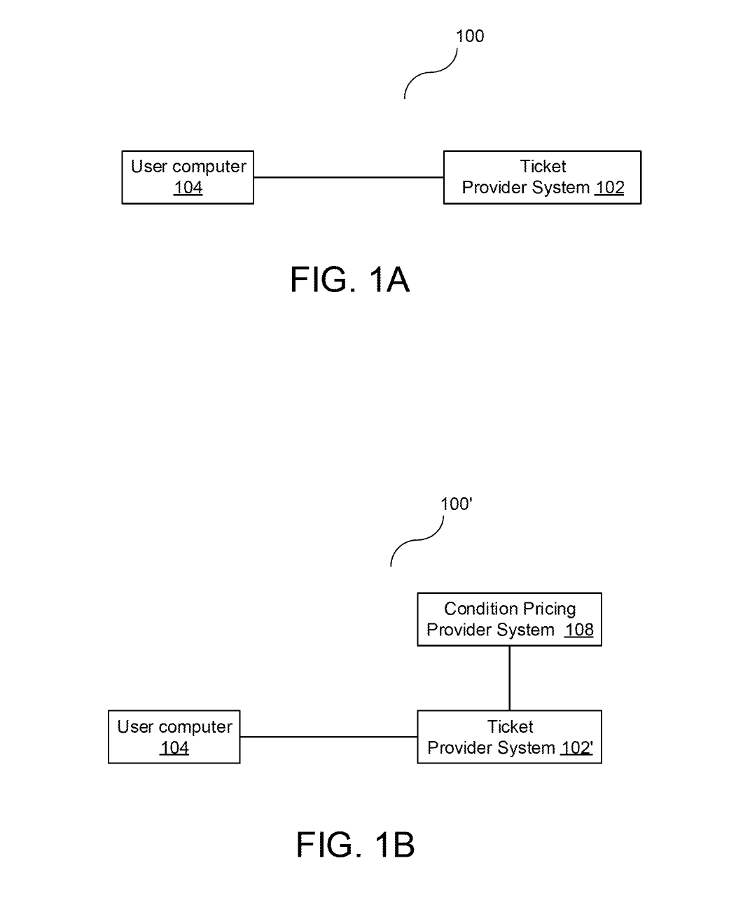

Referring to FIG. 1A, a system 100 is an example of a system to provide event ticket pricing based on a condition. The system 100 includes a ticket provider system 102 and a user computer 104. The ticket provider system 102 receives a request for ticket(s) from a user (e.g., a ticket buyer) using the user computer 104 and provides the user computer 104 with ticket option(s) that includes at least one condition. After receiving a selection of ticket option from the user using the user computer 104, the ticket provider system 102 determines if the condition was met and the ticket provider system 102 enables a refund to the user if the condition was met.

In one example, the user computer 104 may be a personal computer, a smartphone, a personal digital assistant and so forth. In one example, the ticket provider system 102 provides a website which may be accessed by the user computer 104 using, for example, the Internet.

Referring to FIG. 1B, a system 100′ is another example of a system to provide event ticket pricing based on a condition. The system 100′ includes a ticket provider system 102′, the user computer 104 and a condition pricing provider system 108. The condition pricing provider system 108 provides pricing based on a condition. In one example, the ticket provider system 102′ provides pricing on the ticket options(s) based on the pricing provided by the condition pricing provider system 108. In one particular example, the condition pricing provider system 108 provides insurance to the ticket provider system 102′ for each condition.

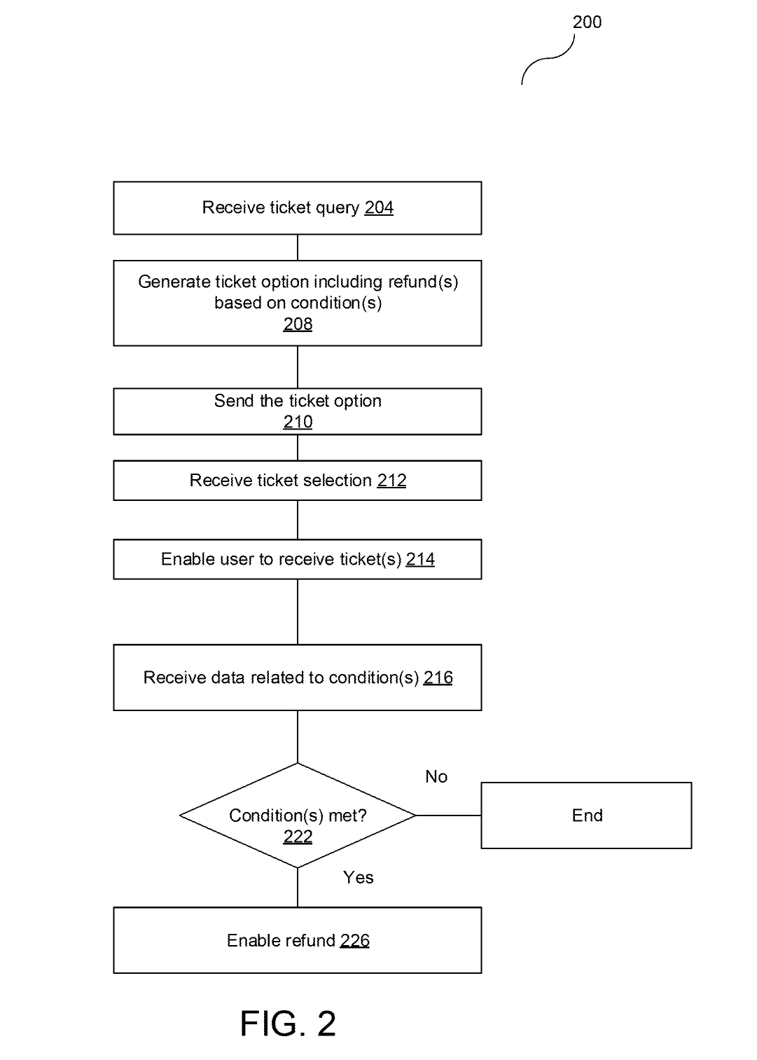

Referring to FIG. 2, a process 200 is an example of a process to provide event ticket pricing based on a condition. Process 200 receives a ticket query (204). For example, a user, using the user computer 104, sends a search query for ticket(s) to a spectator event on a website provided by the ticket provider system 104. In one example, a ticket query may include a query for one or more tickets. In one particular example, the ticket query may include all or a portion of season tickets.

Process 200 generates ticket option including refund(s) based on condition(s) (208). For example, a ticket option may include a date of the spectator event, location of the seat and price of ticket. In one example, for a sporting event, the ticket option may include teams playing. In one example, for a music event, the ticket option may include the artist(s).

In other examples, the ticket option includes a condition and a refund action if the condition occurs. For example, a ticket option for a baseball game may indicate that if the home team loses by five runs or more, the user will receive 50% of the ticket price back. In another example, a ticket option for a baseball game may indicate that if the home team is shutout, the user will receive 40% of the ticket price back. In further example, a ticket option for a baseball game may include that if the temperature is below a specified temperature the user will receive 30% of the ticket price back. In a further example, a ticket option for a baseball game where the home team loses after leading by 3 runs or more in the 7^{th} inning or later. In a still further example, a ticket option for a baseball game may include that if a specified player does not play, the user will receive 20% of the ticket price back.

In other examples, a ticket option may include conditions that may occur before the spectator event. In one particular example, the condition may be a number of games won by a home team at a specified point in the season or what place a home team is in team standing at a specified point in a season.

In further examples, a ticket option may include more than one condition. For example, a ticket option for a baseball game may indicate that if the home team is shutout and the home team loses by five runs or more the user will receive 60% of the ticket price back.

Process 200 sends the ticket option (210). For example, the ticket option is sent electronically using for example, a webpage generated by the ticket provider system 102.

Process 200 receives the ticket selection (212). For example, the user selects a ticket option by entering a ticket option using the user computer 104 on a webpage provided by the ticket provider system 102 and purchases the ticket(s).

Process 200 enables user to receive ticket(s) (214). For example, the ticket provider system 102 delivers tickets electronically or physically to the user.

Process 200 receives data related to the condition(s) (216). For example, the ticket provider system 102 receives data on the spectator event related to the condition in the ticket option selected by the user. In one particular example, a website at the ticket provider system 102 receives data electronically and automatically on the results of a game and/or other conditions (e.g., temperature). In another particular example, the data from the spectator event is entered manually using a graphical user interface (GUI) on the ticket provider system 102.

In one example, the data related to the condition(s) may be received by the ticket provider system 102 during or after the spectator event. In another example, the data related to the condition(s) may be received by the ticket provider system 102 before the spectator event.

Process 200 determines if condition(s) was met (222). For example, the ticket provider system 102 determines if the condition has been met.

If the condition(s) was met, process 200 enables refund (226). For example, the ticket provider system 102 enables payment to the user by check, electronic funds transfer, credit card refund or giving credit based on the refund in the ticket option selected.

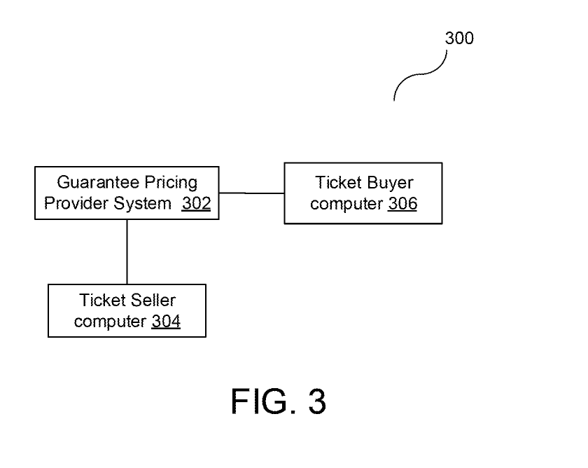

Referring to FIG. 3, a system 300 is an example of a system to provide event ticket pricing based on a condition to ticket sellers to offer to ticket buyers. For example, a ticket buyer may be able to offer a guarantee in selling a ticket based on a condition. The system 300 includes a guarantee pricing provider system 302, a ticket seller computer 304 and a ticket buyer computer 306. The guarantee pricing provider system 302 provides tickets being sold by a ticket seller computer with a refund if a condition(s) is met.

In one example, the ticket seller computer 304 and the ticket buyer computer 306 may be a personal computer, a smartphone, a personal digital assistant and so forth. In one example, the guarantee pricing provider system 302 provides a website which may be accessed by the ticket buyer computer 304 and the ticker seller computer 106 using, for example, the Internet.

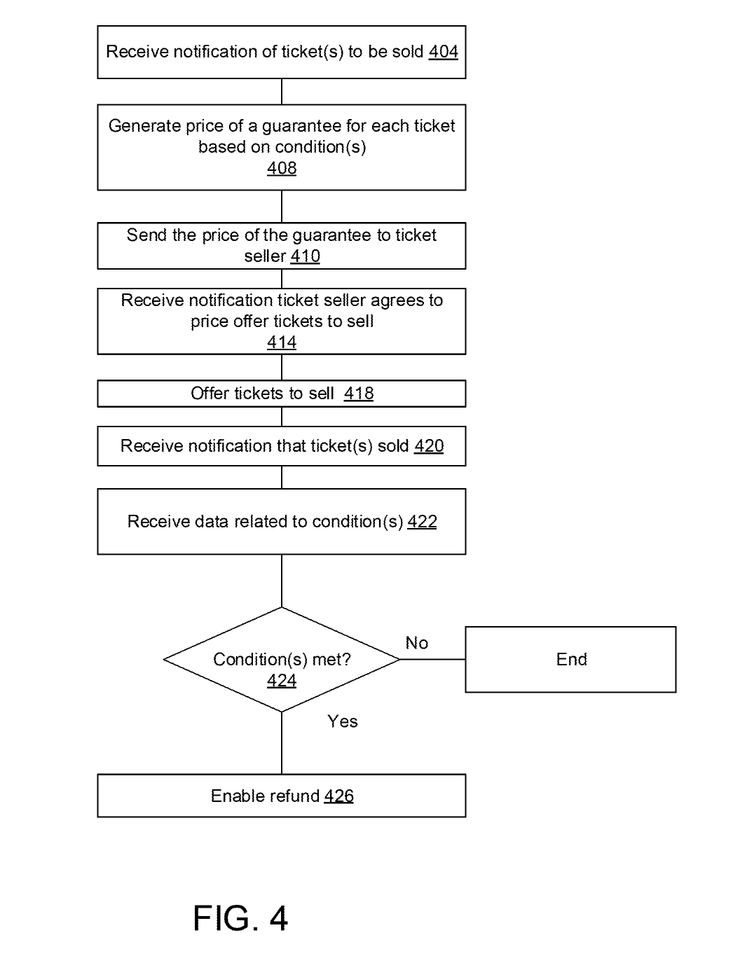

Referring to FIG. 4, a process 400 is an example of a process to provide event ticket pricing based on a condition to ticket sellers to offer to ticket buyers. Process 400 receives notification of tickets to be sold (404). For example, the ticket seller using the ticket seller computer 304 notifies the guarantee pricing provider system 302 of tickets to sell. In one example, tickets to be sold may include one or more tickets. In one particular example, the ticket to be sold may include all or a portion of season tickets.

Process 400 generates a price of a guarantee for each ticket based on conditions (408). In one example, the guarantee pricing provider system 302 performs calculations to determine an appropriate price for a guarantee. For example, a price of a guarantee may include a price to refund a ticket and the amount or percentage to refund the ticket buyer if the condition is met. For example, a price of a guarantee for a baseball game may be a price for a refund of 50% of the ticket price to the ticket buyer if the home team loses by more than five runs. In another example, a price of guarantee for a baseball game may be a price for a refund of 40% of the ticket price to the ticket buyer if the home team is shutout. In further example, a price of guarantee for a baseball game may be a price for a refund of 30% of the ticket price to the ticket buyer if the temperature is below a specified temperature. In a still further example, a price of guarantee for a baseball game may be a price for a refund of 20% of the ticket price to the ticket buyer if a specified player does not play.

In other examples, a ticket option may include conditions that may occur before the spectator event. In one particular example, the condition may be a number of games won by a home team at a specified point in the season or what place a home team is in team standing at a specified point in a season.

In further examples, a price of a guarantee may include more than one condition. For example, a price of a guarantee for a baseball game may be a price for a refund of 60% of the ticket price to the ticket buyer if the home team is shutout and the home team loses by more than five runs.

In one particular example, one or more of the following information is inputted into the guarantee pricing provider system 302 to determine a price of a guarantee: type of event, name of event, place of event, date of event, participants in the event (e.g., teams, performers, and so forth), price of the tickets, number of tickets; potential percentage refund; and the contingency selected. In one particular example, the guarantee pricing provider system 302 may use one or more of the following information to determine the loss probability, evaluate risk and determine pricing of the guarantee: historical data relating to the contingency selected, the type of event, place of event; participants in the event; price of the ticket; number of tickets; and the potential percentage refund. In one particular example, the guarantee pricing provider system 302 may combine the historical data above with the number and cost of tickets, to generate the level of risk and potential loss/payout data. Once the level of risk and potential loss is established, the guarantee pricing provider system 302 may determine pricing based upon the acceptable risk to the grantor of the guarantee. Once the loss probability is calculated, the guarantee pricing provider system 302 may output one or more of the following information: the loss probability and the price for the guarantee.

In another particular example, one or more of the following information is inputted into the guarantee pricing provider system 302 to determine the price of the guarantee: the sport; name of home team; description of ticket package; price of the ticket package, number of tickets within the ticket package; potential percentage refund; first contingency selected; second contingency selected; additional contingencies; if more than one contingency is selected, whether only one, or more than one, of the contingencies must occur; contingency measurement point; and data from multiple sources with respect to the expected performance of the team for that season. In one particular example, the guarantee pricing provider system 302 may use one or more of the following information to determine the loss probability, evaluate risk and determine pricing: the sport; the home team; the price of the ticket package; the number of tickets within the ticket package; the potential percentage refund; the contingency or contingencies selected; whether only one, or more than one, of the contingencies must occur; and data from multiple sources with respect to the expected performance of the team for that season. The guarantee pricing provider system 302 may combine the data set forth above, to generate the level of risk and potential loss/payout data. In one example, after the level of risk and potential loss is established, the guarantee pricing provider system 302 may determine pricing based upon the acceptable risk to the provider of the financial backing for the guarantee. Once the loss probability is determined the guarantee pricing provider system 302 may output one or more of the following information: the loss probability, the maximum payout; the likely payout; and the price for the guarantee.

Process 400 sends the price of the guarantee to ticket seller (410). For example, the guarantee pricing provider system 302 sends the pricing of the guarantee for the tickets by updating a webpage.

Process 400 receives notification that ticket seller agrees to the price of the guarantee (414). For example, a ticket seller using the ticket seller computer 304 acknowledges on the webpage that the price of the guarantee is accepted.

Process 400 offers tickets to sell (418). For example, the guarantee pricing provider system 302 offers the ticket to be sold using a webpage.

Process 400 receives notification that tickets(s) sold (420). For example, the guarantee pricing provider system 302 sells the tickets.

Process 400 receives data related to the condition(s) (422). For example, the guarantee pricing provider system 302 receives data on the spectator event related to the condition. In one particular example, a website at the guarantee pricing provider system 302 receives data electronically automatically regarding the results of a game and/or other conditions (e.g., temperature). In another particular example, the data from the spectator event is entered manually using a GUI. In one example, the data from the spectator event may be received during or after the spectator event. In another example, the data related to the condition(s) may be received by the ticket provider system 102 before the spectator event.

Process 400 determines if condition(s) are met (424). For example, the guarantee pricing provider system 302 determines if the condition was met by analyzing the data received in processing block 422.

If the condition(s) was met, process 400 enables a refund (426). For example, the guarantee pricing provider system 302 enables payment to the ticket buyer by check, electronic funds transfer, credit card refund or giving credit, based upon the specified payout.

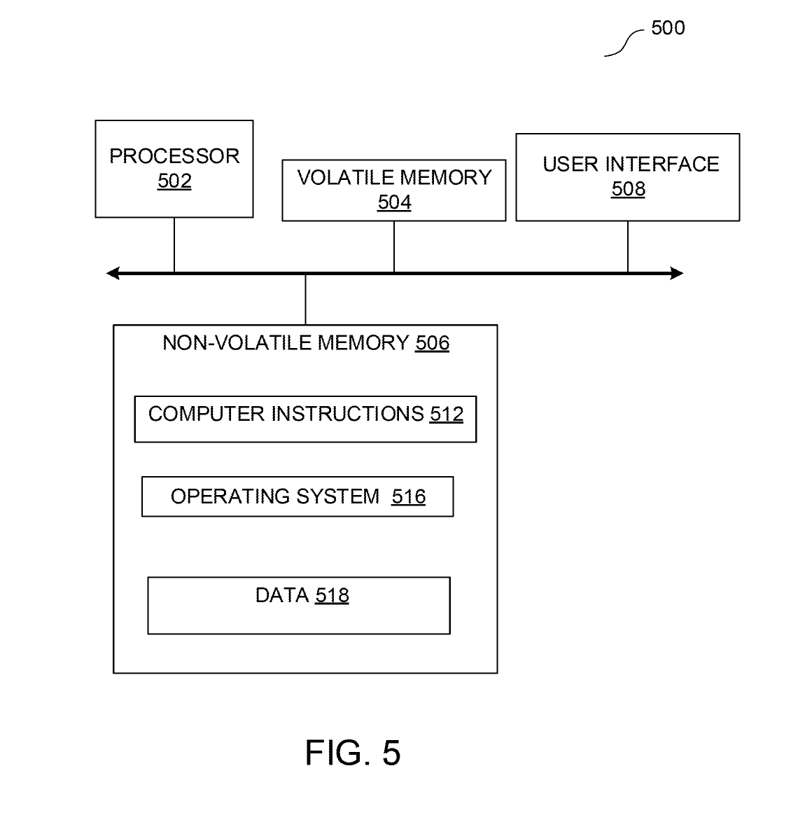

Referring to FIG. 5, in one example, the ticket provider system 102 (FIG. 1A), the ticket prover 102′ (FIG. 1B) and or the guarantee pricing provider system 302 may include a computer 500. In one example, the computer 300 may include a processor 502, a volatile memory 504, a non-volatile memory 506 (e.g., flash memory, hard disk and so forth) and the user interface (UI) 508 (e.g., a graphical user interface, a mouse, a keyboard, a display, touch screen and so forth). The non-volatile memory 506 stores computer instructions 512, an operating system 516 and data 518. In one example, the computer instructions 512 may be executed by the processor 502 out of volatile memory 504 to perform any portion of the processes described herein (e.g., the processes 200 and 400).

The processes described herein (e.g., the processes 200 and 400) are not limited to use with the hardware and software of FIG. 5; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a non-transitory machine-readable medium or other article of manufacture that is readable by the processor (including volatile and non-volatile memory and/or storage elements), at least one input device, and one or more output devices. Program code may be applied to data entered using an input device to perform any of the processes described herein and to generate output information.

The system may be implemented, at least in part, via a computer program product, (e.g., in a non-transitory machine-readable storage medium such as, for example, a non-transitory computer-readable medium, for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, volatile memory, magnetic diskette and so forth but does not include a transitory signal per se.

The processes described herein are not limited to the specific examples described. For example, the processes 200 and 400 are not limited to the specific processing order of FIGS. 2 and 4. Rather, any of the processing blocks of FIGS. 2 and 4 may be re-ordered, combined or removed, performed in parallel or in serial, as necessary, to achieve the results set forth herein.

The processing blocks (for example, in the processes 200 and 400) associated with implementing the system may be performed by one or more programmable processors executing one or more computer programs to perform the functions of the system. All or part of the system may be implemented as, special purpose logic circuitry (e.g., an FPGA (field-programmable gate array) and/or an ASIC (application-specific integrated circuit)). All or part of the system may be implemented using electronic hardware circuitry that include electronic devices such as, for example, at least one of a processor, a memory, a programmable logic device or a logic gate.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A method comprising:
receiving electronically a ticket query for a spectator event;
generating, in response to the ticket query, a ticket option comprising a refund based on at least one condition;
sending electronically the ticket option;
receiving electronically a ticket selection of the ticket option comprising the at least one condition;
receiving data related to the at least one condition;
determining if the at least one condition has occurred based on the data received; and
enabling a refund if the at least one condition is met.

2. The method of claim 1, wherein receiving electronically a ticket query for a spectator event comprises receiving electronically a ticket query for one of a play, a musical or a concert.

3. The method of claim 1, wherein receiving electronically a ticket query for a spectator event comprises receiving electronically a ticket query for a sporting event.

4. The method of claim 3, wherein receiving electronically a ticket query for a sporting event comprises receiving electronically a ticket query for a sporting event. comprising one of baseball, football, hockey, basketball, volleyball or soccer.

5. The method of claim 3, wherein generating the ticket option comprising a refund based on at least one condition comprises generating a ticket option comprising a refund based on at least one condition comprising at least one of:
a home team loses by a specified amount of runs or points;
the home team is shutout;
the home team loses after leading at a certain point in a game;
a temperature at the spectator event is below a specified temperature;
a specified player does not play in the sporting event;
a number of games won by a home team at a specified point in a season; or
a place of a home team is in team standings at a specified point in a season.

6. The method of claim 1, wherein receiving electronically the ticket query for a spectator event comprises receiving electronically a ticket query for a spectator event on a webpage.

7. The method of claim 1, wherein enabling a refund if the at least one condition is met comprises enabling payment to the user by check, electronic funds transfer, credit card refund or giving credit.

8. The method of claim 1, wherein receiving data related to the at least one condition comprises receiving the data electronically.

9. An apparatus, comprising:
electronic hardware circuitry configured to:
receive electronically a ticket query for a spectator event;
generate, in response to the ticket query, a ticket option comprising a refund based on at least one condition;
send electronically the ticket option;
receive electronically a ticket selection of the ticket option comprising the at least one condition;
receive data related to the at least one condition;
determine if the at least one condition has occurred based on the data received; and
enable a refund if the at least one condition is met,
wherein the circuitry comprises at least one of a processor, a memory, a programmable logic device or a logic gate.

10. The apparatus of claim 9, wherein the circuitry configured to receive electronically a ticket query for a spectator event comprises circuitry configured to receive electronically a ticket query for one of a play, a musical, a concert or a sporting event.

11. The apparatus of claim 10, wherein the circuitry configured to receive electronically a ticket query for a sporting event comprises circuitry configured to receive electronically a ticket query for a sporting event. comprising one of baseball, football, hockey, basketball, volleyball or soccer,
wherein the circuitry configured to generate the ticket option comprising a refund based on at least one condition comprises circuitry configured to generate a ticket option comprising a refund based on at least one condition comprising at least one of:
a home team loses by a specified amount of runs or points;
the home team is shutout;
the home team loses after leading at a certain point in a game;
a temperature at the spectator event is below a specified temperature;
a specified player does not play in the sporting event;
a number of games won by a home team at a specified point in a season; or
a place of a home team is in team standings at a specified point in a season.

12. The apparatus of claim 11, wherein the circuitry configured to receive electronically the ticket query for a spectator event comprises circuitry configured to receive electronically a ticket query for a spectator event on a webpage.

13. The apparatus of claim 9, wherein the circuitry configured to enable a refund if the at least one condition is met comprises circuitry configured to enable payment to the user by check, electronic funds transfer, credit card refund or giving credit.

14. The apparatus of claim 9, wherein the circuitry configured to receive data related to the at least one condition comprises circuitry configured to receive the data electronically.

15. An article comprising:
a non-transitory computer-readable medium that stores computer-executable instructions, the instructions causing a machine to:
receive electronically a ticket query for a spectator event;
generate, in response to the ticket query, a ticket option comprising a refund based on at least one condition;
send electronically the ticket option;
receive electronically a ticket selection of the ticket option comprising the at least one condition;
receive data related to the at least one condition;
determine if the at least one condition has occurred based on the data received; and
enable a refund if the at least one condition is met.

16. The article of claim 14, wherein the instructions causing the machine to receive electronically a ticket query for a spectator event comprises instructions causing the machine to receive electronically a ticket query for one of a play, a musical, a concert or a sporting event.

17. The article of claim 16, wherein the instructions causing the machine to receive electronically a ticket query for a sporting event comprises instructions causing the machine to receive electronically a ticket query for a sporting event. comprising one of baseball, football, hockey, basketball, volleyball or soccer,
wherein the instructions causing the machine to generate the ticket option comprising a refund based on at least one condition comprises instructions causing the machine to generate a ticket option comprising a refund based on at least one condition comprising at least one of:
a home team loses by a specified amount of runs or points;
the home team is shutout;
the home team loses after leading at a certain point in a game;
a temperature at the spectator event is below a specified temperature;
a specified player does not play in the sporting event;
a number of games won by a home team at a specified point in a season; or
a place of a home team is in team standings at a specified point in a season.

18. The article of claim 17, wherein the instructions causing the machine to receive electronically the ticket query for a spectator event comprises instructions causing the machine to receive electronically a ticket query for a spectator event on a webpage.

19. The article of claim 14, wherein the instructions causing the machine to enable a refund if the at least one condition is met comprises instructions causing the machine to enable payment to the user by check, electronic funds transfer, credit card refund or giving credit.

20. The article of claim 14, wherein the instructions causing the machine to receive data related to the at least one condition comprises instructions causing the machine to receive the data electronically.

21. A method comprising:
receiving electronically notification of a ticket to sell to a spectator event;
generating a price of a guarantee for the ticket based on at least one condition;
sending the price of the guarantee;
sending electronically the ticket option;
receiving electronically acceptance of the price of the guarantee;
receiving electronically notification that the tickets sold;
determining if the at least one condition has occurred based on data received; and
enabling a refund if the at least one condition is met.

22. The method of claim 21, wherein receiving electronically notification of a ticket to sell to a spectator event comprises receiving electronically notification of a ticket to sell to a sporting event.

23. The method of claim 22, wherein generating a price of a guarantee for the ticket based on at least one condition comprises generating a price of a guarantee for the ticket based on at least one condition comprising at least one of:
a home team loses by a specified amount of runs or points;
the home team is shutout;
the home team loses after leading at a certain point in a game;
a temperature at the spectator event is below a specified temperature;
a specified player does not play in the sporting event;
a number of games won by a home team at a specified point in a season; or
a place of a home team is in team standings at a specified point in a season.

24. The method of claim 21, wherein receiving electronically notification of a ticket to sell to a spectator event comprises receiving electronically notification of a ticket to sell to a spectator event on a webpage.

25. The method of claim 21, wherein enabling a refund if the at least one condition is met comprises enabling payment to the user by check, electronic funds transfer, credit card refund or giving credit.

26. The method of claim 21, wherein receiving electronically a ticket query for a spectator event comprises receiving electronically a ticket query for one of a play, a musical or a concert.
